(19) United States
(12) Patent Application Publication
(10) Pub. No.: US 2006/0160449 A1
(43) Pub. Date: Jul. 20, 2006

(54) Moisture-absorbing, quick drying, thermally insulating, elastic laminate and method for making the same

(75) Inventors: Ko-Feng Wang, Fengshan (TW); I-Peng Yao, Sanmin (TW); Kun-Lin Chiang, Ziguan (TW)

Correspondence Address: NIKOLAI & MERSEREAU, P.A., 900 SECOND AVENUE SOUTH, SUITE 820, MINNEAPOLIS, MN, 55402, US

(73) Assignee: SAN FANG CHEMICAL INDUSTRY CO., LTD., Jenwu Shiang (TW)

(21) Appl. No.: 11/270,436

(22) Filed: Nov. 9, 2005

Related U.S. Application Data
(63) Continuation-in-part of application No. 11/199,437, filed on Aug. 8, 2005.

(30) Foreign Application Priority Data
Jan. 19, 2005 (TW) 094101604

(51) Int. Cl. D03D 15/00; D03D 15/08; B23B 5/02; B32B 15/14; B44C 1/17

(52) U.S. Cl. 442/182; 442/181; 442/183; 442/228; 442/232; 442/234; 156/233

(57) ABSTRACT

There is disclosed a moisture-absorbing, quick drying, thermally insulating, elastic, composite material and a method for making the same. Adhesive is provided on the top and bottom of a highly porous foil so that the adhesive does not form a continuous film. By means of the adhesive, two sheets of elastic fabric are adhered to the top and bottom of the highly porous foil in order to provide a composite material. The composite material is low in density and high in porosity. As the adhesive does not form a continuous film, the composite material is highly porous and is called a moisture-absorbing, quick drying, thermally insulating, elastic, composite material.

### CROSS REFERENCE TO RELATED APPLICATION

This is a continuation-in-part application of U.S. patent application Ser. No. 11/199,437 filed Aug. 8, 2005.

### BACKGROUND OF INVENTION

1. Field of Invention

The present invention relates to clothes and footgear and, more particularly, to a moisture-absorbing, quick drying, thermally insulating, elastic laminate for use in clothes and footgear and a method for making the same.

2. Related Prior Art

Conventional laminates for use in clothes and footgear are dense. Such a laminate includes layers that are not highly porous. The layers are adhered to one another by means of adhesive that forms a continuous film between any adjacent two thereof. The adhesive film does not provide sufficient pores for passing moisture between any adjacent two of the layers nor enough space for retaining air, and is not highly permeable nor thermally insulating. In addition, limited by the layers of the laminates, the laminates fail to provide elasticity.

In U.S. Pat. No. 6,451,716, “Leather-like sheet and process for the production thereof”, is disclosed a method for making a leather-like laminate that is permeable regarding air and moisture. Nylon or polyethylene terephthalate (“PET”) sea-island fibers of less than 0.2 deniers are used to make non-woven fabric. The non-woven fabric is submerged in a macromolecular elastomer solution before it is coated with a macromolecular elastomeric polymer. Curing, removal of Dimethylformamide (“DMF”) and drying are conducted. With a #250 gravure roller, a solvent is provided onto the surface of the polymer in order to dissolve some of the polymer and make pores in the surface of the polymer. Then, the sea portion of the fibers is removed. Before or after a superficial finishing layer is formed, the leather-like laminate is hot-pressed.

FIGS. 1 and 2 show an elastic and permeable laminate 10 as disclosed in Taiwanese Patent Publication No. 532282. The laminate 10 includes a fabric layer 11 and an elastic layer 12. The fabric layer 11 is made of micro fibers and could be non-woven fabric or ordinary fabric. The fabric layer 11 includes a substrate 111 made with a pre-determined shape and laces 112 tied to the substrate 111. The laces 112 could be fibers or yarns. The elastic layer 12 is made from a closed-pore foam material with pre-determined thickness. The foam material could be plastic or rubber such as ethylene-vinyl acetate copolymer (“EVA”), polyethylene (“PE”), polyurethane (“PU”), nitrile-butadiene rubber (“NBR”) and styrene-butadiene rubber (“SBR”). The elastic layer 12 includes a lower surface 121 towards the fabric layer 11 and an upper surface 122 opposite to the lower surface 121. By means of needling, apertures 123 are made in the elastic layer 12 from the top 122 to the bottom 121, and the laces 112 are pulled through the apertures 123 in order to firmly bind the fabric layer 11 to the elastic layer 12. The apertures 123 provide permeability. Thus, the laminate 10 is elastic and permeable regarding air. The laces 112 exposed from the elastic layer 12 provide the feel and look of fabric. However, the apertures 123 are aesthetically unpleasant. Moreover, the laminate 10 exhibits poor permeability regarding moisture.

The present invention is therefore intended to obviate or at least alleviate the problems encountered in prior art.

### SUMMARY OF INVENTION

The primary objective of the present invention is to provide a method for making a laminate that is elastic and permeable regarding air and moisture.

According to the present invention, a method making a laminate includes a plurality of steps. A foil with a low density (0.18 to 0.3 g/cm³) and a high porosity (60% to 90%) is taken as a substrate. Because of the high porosity, a large proportion of the infrastructure of the substrate is pores. The large amount of the irregular pores and the big total area of the surface provide a lot of space for absorbing fluid (such as sweat and air) from the exterior. The non-dense infrastructure renders the substrate low in density, high in extensibility, highly moisture-absorbing, quick drying, highly permeable regarding air and moisture, and thermally insulating. This is not like any ordinary substrate with a dense infrastructure that cannot absorb a lot of fluid from the exterior. Moreover, adhesive is provided on upper and lower surfaces of the substrate in a dot matrix or lattice. Thus, the adhesive does not form a continuous and dense film, but provides a lot of pores and gaps for exchange of fluid between two layers adhered to each other thereby and absorption of fluid from the exterior. By means of the adhesive, two elastic layers are adhered to the upper and lower surfaces of the substrate. The elastic layers render the laminate elastic. Thus, the laminate is rendered moisture-absorbing, quick drying, thermally insulating and elastic.

Other objectives, advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is an exploded view of a laminate disclosed in Taiwanese Patent Publication No. 532282.

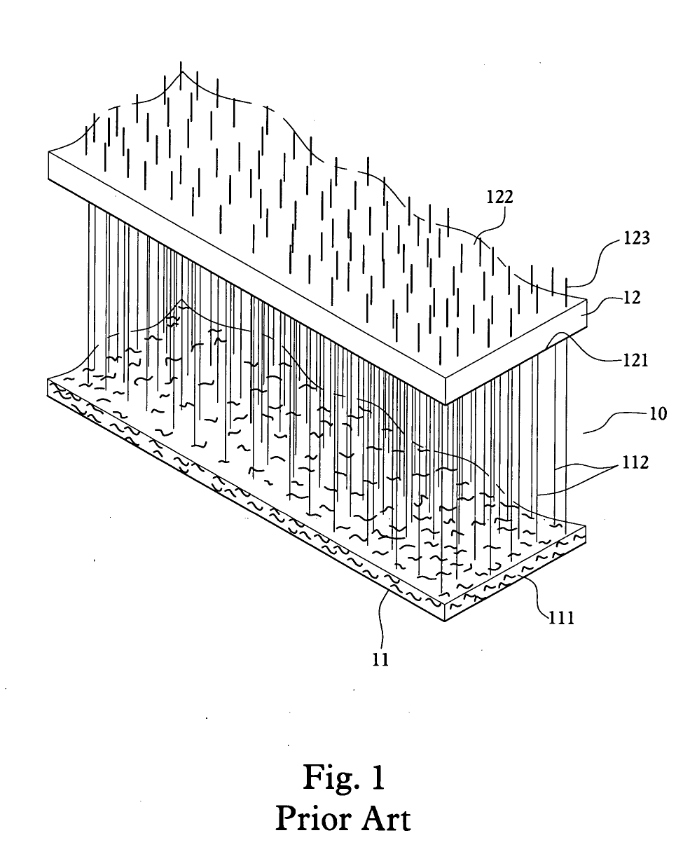

FIG. 2 is a cross-sectional view of the laminate shown in FIG. 1.

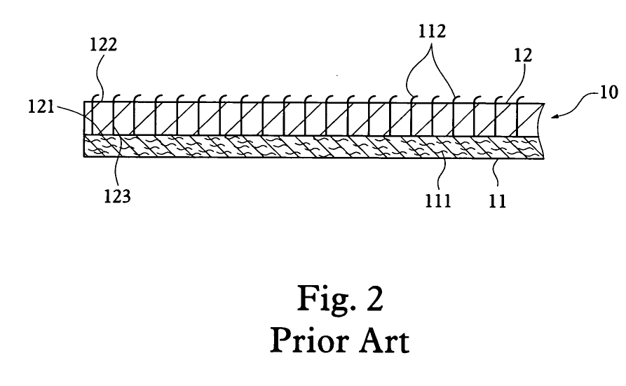

FIG. 3 is a cross-sectional view of a moisture-absorbing, quick drying, thermally insulating, elastic laminate according to the preferred embodiment of the present invention.

FIG. 4 is a chart for showing values of humidity of sports underwear of the present invention compared with values of humidity of for-sale sports underwear while a wearer is exercising.

FIG. 5 is a chart for showing temperatures of a person while wearing sports underwear of the present invention compared with temperatures of the person while wearing for-sale sports underwear.

### DETAILED DESCRIPTION OF PREFERRED EMBODIMENT

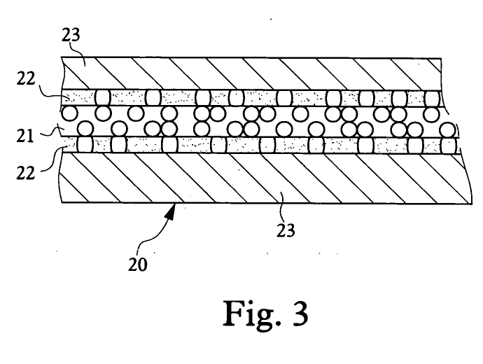

Referring to FIG. 3, there is shown a moisture-absorbing, quick drying, thermally insulating, elastic laminate 20 according to the preferred embodiment of the present invention. There is provided a foil 21 with a low density and a high porosity. Adhesive 22 is provided onto two sides of the foil 21 so that it does not form a continuous film. By means of the adhesive, two elastic layers 23 are adhered to the sides of the foil 21. Thus, the laminate 20 is rendered moisture-absorbing, quick drying, thermally insulating, and elastic.

In a first example of the laminate 20 according to the preferred embodiment, the foil 21 is made from PU with a thickness of 0.3 mm and a porosity rate of 80%. The foil 21 is put on a workbench. The adhesive 22 is provided onto one of the sides of the foil 21 so that the area covered by the adhesive 22 is 60% of the area of the side of the foil 21. One of the elastic layers 23 is adhered to the foil 21. After the adhesive 22 is cured, the foil 21 is inversed and put back onto the workbench. The adhesive 22 is provided onto the remaining side of the foil 21. The remaining elastic layer 23 is adhered to the foil 21. Thus, the laminate 20 is rendered moisture-absorbing, quick drying, thermally insulating, and elastic.

In a second example of the laminate according to the preferred embodiment, the foil 21 is made from PU with a thickness of 0.3 mm and a porosity rate of 80%. The foil 21 is put on a workbench. The adhesive 22 is provided onto one of the sides of the foil 21 so that the area covered by the adhesive 22 is 40% of the area of the side of the foil 21. One of the elastic layers 23 is adhered to the foil 21. After the adhesive 22 is cured, the foil 21 is inversed and put back onto the workbench. The adhesive 22 is provided onto the remaining side of the foil 21. The remaining elastic layer 23 is adhered to the foil 21. Thus, the laminate 20 is rendered moisture-absorbing, quick drying, thermally insulating, and elastic.

In a third example of the laminate according to the preferred embodiment, the foil 21 is made from PU with a thickness of 0.3 mm and a porosity rate of 80%. The foil 21 is put on a workbench. The adhesive 22 is provided onto one of the sides of the foil 21 so that the area covered by the adhesive 22 is 20% of the area of the side of the foil 21. One of the elastic layers 23 is adhered to the foil 21. After the adhesive 22 is cured, the foil 21 is inversed and put back onto the workbench. The adhesive 22 is provided onto the remaining side of the foil 21. The remaining elastic layer 23 is adhered to the foil 21. Thus, the laminate 20 is rendered moisture-absorbing, quick drying, thermally insulating, and elastic.

In a fourth example of the laminate according to the preferred embodiment, the foil 21 is made from PU with a thickness of 0.5 mm and a porosity rate of 80%. The foil 21 is put on a workbench. The adhesive 22 is provided onto one of the sides of the foil 21 so that the area covered by the adhesive 22 is 60% of the area of the side of the foil 21. One of the elastic layers 23 is adhered to the foil 21. After the adhesive 22 is cured, the foil 21 is inversed and put back onto the workbench. The adhesive 22 is provided onto the remaining side of the foil 21. The remaining elastic layer 23 is adhered to the foil 21. Thus, the laminate 20 is rendered moisture-absorbing, quick drying, thermally insulating, and elastic.

In a fifth example of the laminate according to the preferred embodiment, the foil 21 is made from PU with a thickness of 0.3 mm and a porosity rate of 40%. The foil 21 is put on a workbench. The adhesive 22 is provided onto one of the sides of the foil 21 so that the area covered by the adhesive 22 is 60% of the area of the side of the foil 21. One of the elastic layers 23 is adhered to the foil 21. After the adhesive 22 is cured, the foil 21 is inversed and put back onto the workbench. The adhesive 22 is provided onto the remaining side of the foil 21. The remaining elastic layer 23 is adhered to the foil 21. Thus, the laminate 20 is rendered moisture-absorbing, quick drying, thermally insulating, and elastic.

As disclosed in U.S. Pat. No. 6,451,716, a gravure roller is used to provide a solvent onto the surface of a PU foam layer that is not permeable regarding air and moisture in order to dissolve some of the polymer and make pores in the surface of the polymer. However, the permeability regarding air and the permeability regarding moisture of the resultant laminate are low. Not like the conventional laminate, the laminate of the present invention is low in density, high in porosity, and highly permeable regarding air and moisture. If the thickness is 0.3 mm, the permeability regarding air will be more than 500 L/cm²Hr, and the permeability regarding moisture 25 mg/cm²Hr. If the thickness is 0.5 mm, the permeability regarding air will be more than 400 L/cm²Hr, and the permeability regarding moisture 22 mg/cm²Hr.

The examples of the laminate of the present invention are compared with the conventional laminate of U.S. Pat. No. 6,451,716, and the result is shown in Table 1.

TABLE 1

| | Example | Example | Example | Example | Example | U.S. Pat. |
|---|---|---|---|---|---|---|
| | 1 | 2 | 3 | 4 | 5 | No. 6451716 |
| Permeability regarding | 20 | 19 | 20 | 19 | 6.2 | 5.0 above |
| moisture (TM172) | | | | | | |
| mg/cm²Hr | | | | | | |
| Permeability regarding | 257 | 277 | 293 | 247 | 12 | 0.5 above |
| air (JIS P8111) | | | | | | |
| L/cm²Hr | | | | | | |
| Extensibility (T) % | 163 | 157 | 163 | 155 | 160 | |
| Extensibility (Y) % | 256 | 255 | 254 | 260 | 260 | |
| Density g/cm³ | 0.25 | 0.25 | 0.25 | 024 | 0.26 | 0.37-0.65 |
| Thickness mm | 1.45 | 1.52 | 1.45 | 1.60 | 1.45 | |
| softness % | 29.6 | 28.3 | 29.0 | 28.1 | 22.0 | |

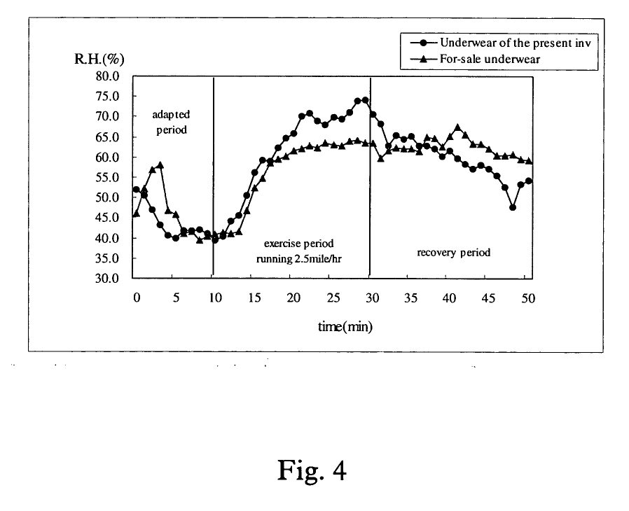

FIG. 4 shows the result of comparison of sports underwear made of the first example of the laminate of the present invention with for-sale sports underwear. The humidity of the sports underwear is measured near the chest of a wearer doing aerobic exercise at a temperature of 27 degrees Celsius and a humidity of 65%. When the wearer is exercising, the humidity of the sports underwear of the present invention is higher that that of the for-sale sports underwear, i.e., the former absorbs moisture better than the latter. When the wearer is resting, the humidity of the sports underwear of the present invention soon gets lower than that that of the for-sale sports underwear, i.e., the former dries faster than the latter.

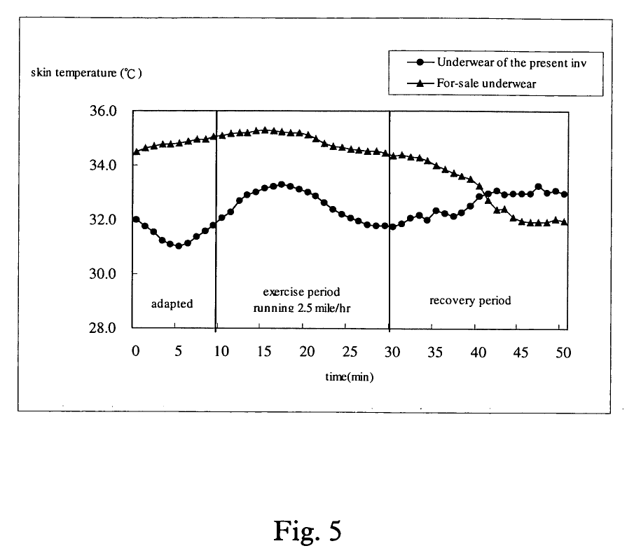

FIG. 5 shows the result of comparison of sports underwear made of the first example of the laminate of the present invention with for-sale sports underwear. Temperature is measured near the chest of a wearer doing aerobic exercise at a temperature of 27 degrees Celsius and a humidity of 65%.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A method for making a moisture-absorbing, quick drying, thermally insulating, elastic laminate, the method comprising the steps of:
providing a foil with high porosity;
providing adhesive onto at least one side of the foil so that the adhesive does not form a continuous film; and
adhering elastic fabric to the foil by means of the adhesive.

2. The method according to claim 1 wherein the foil is made of at least one material selected from a group consisting of polyurethane, polyolefin, ethylene-vinyl acetate copolymer (“EVA”), polyethylene terephthalate, polyamide and polyester.

3. The method according to claim 1 wherein the foil comprises continuous pores.

4. The method according to claim 1 wherein the foil comprises a density of 0.1 to 0.3 g/cm³.

5. The method according to claim 1 wherein the porosity is 60% to 90%.

6. The method according to claim 1 wherein the foil comprises a thickness of 0.1 to 1.0 mm.

7. The method according to claim 1 wherein the adhesive is provided in dots.

8. The method according to claim 7 wherein 10% to 95% areas of the side of the foil is covered by the adhesive.

9. The method according to claim 1 wherein the elastic fabric is made of at least one material selected from a group consisting of nylon, polyester, protein, cotton, rayon and polyurethane.

10. A moisture-absorbing, quick drying, thermally insulating, elastic laminate comprising:
a substrate being a foil with high porosity;
two elastic layers each put on a side of the substrate; and
adhesive for adhering the elastic layers to the substrate so that the adhesive does not form a continuous film between each of the elastic layers and the substrate.

11. The laminate according to claim 10 wherein the foil is made of at least one material selected from a group consisting of polyurethane, polyolefin, ethylene-vinyl acetate copolymer (“EVA”), polyethylene terephthalate, polyamide and polyester.

12. The laminate according to claim 10 wherein the foil comprises continuous pores.

13. The laminate according to claim 10 wherein the foil comprises a density of 0.1 to 0.3 g/cm³.

14. The method according to claim 10 wherein the porosity is 60% to 90%.

15. The laminate according to claim 10 wherein the foil comprises a thickness of 0.1 to 1.0 mm.

16. The laminate according to claim 10 wherein 10% to 90% areas of the side of the foil is covered by the adhesive.

17. The laminate according to claim 10 wherein the elastic fabric is made of at least one material selected from a group consisting of nylon, polyester, protein, cotton, rayon and polyurethane.

18. The method according to claim 1 wherein 10% to 95% areas of the side of the foil is covered by the adhesive.
